(19) United States
(12) Patent Application Publication
(10) Pub. No.: US 2025/0129770 A1
(43) Pub. Date: Apr. 24, 2025

(54) CONSTANT TORSION FORCE GENERATOR AND REAL-TIME CONSTANT-FORCE TENSION DEVICE

(71) Applicant: Siping LI, Fuan, Ningde, Fujian (CN)

(72) Inventor: Siping LI, Fuan, Ningde, Fujian (CN)

(21) Appl. No.: 18/682,503

(22) PCT Filed: Sep. 17, 2021
(86) PCT No.: PCT/CN2021/000189

§ 371 Date: Feb. 9, 2024

(30) Foreign Application Priority Data
Aug. 12, 2021 (CN) CN202110925398.X

(51) Int. Cl. F03G 1/02; A63B 21/02; A63B 21/04

(52) U.S. Cl. CPC F03G 1/026; A63B 21/023; A63B 21/0435

(57) ABSTRACT

A constant torsion force generator and a real-time constant-force tension device. The constant torsion force generator comprises: a rotatable power output member; and constant-force coil springs (14), one end of each of the constant-force coil springs being fixed, and the other end thereof being fixed to the power output member. The real-time constant-force tension device comprises: a rotatable rotating shaft (20); a reel (40), around which a draw cord is wound, and which can drive the rotating shaft (20) to rotate; and an independent constant torsion force generator, comprising a rotatable power output member and at least one constant-force coil spring (14), wherein a power connection is formed between the power output member and the rotating shaft (20); the at least one constant-force coil spring (14) is arranged beside the power output member; and one end of each constant-force coil spring (14) is fixed, and the other end thereof is fixed to the power output member. The present invention can replace a weight to generate a torsion force and a tensile force, and has the advantages of being portable, space-efficient, easily stored, low in cost, and adjustable, providing a real-time constant force, etc.

### TECHNICAL FIELD

The present invention relates to a constant torsion force generator that utilizes a coil spring to provide force and may be applied in technical fields such as fitness equipment, machinery industry, aerospace, and automobiles.

### BACKGROUND

Existing tensioning equipment, taking common chest training equipment in gyms as an example, all provide resistance by the traction of metal weight blocks. More common dumbbells and barbell plates are also made of metal to provide different weights. The extensive use of metal materials makes fitness equipment heavy, difficult to move, and costly. Moreover, these metal dumbbells and barbell plates have the risk of injuring during transportation and storage, which is a major obstacle to the entry of strength fitness equipment into the home.

Different from other tensioning equipment on the market, the purpose of the present invention is to provide adjustable real-time constant force, so that users or objects can receive the same force at different speeds to achieve better training effects or more stable output.

### SUMMARY

The present invention provides a constant torque force generator and a real-time constant-force tension device, which use a coil spring to provide force, aim to reduce the usage amount of metal so as to save the cost and reduce the weight, and provide an adjustable real-time constant force.

In order to achieve the above objects, the technical solution adopted by the present invention is:

A constant torque force generator, including:
a rotatable power output member; and
at least one constant-force coil spring, arranged beside the power output member, one end thereof being immobile, and the other end thereof being fixed to the power output member.

The constant torque force generator, where the power output member is an auxiliary output wheel, a rotating shaft that can rotate relatively freely is provided into and extended through the auxiliary output wheel, and a power connection is formed between the auxiliary output wheel and the rotating shaft through a clutch device.

The constant torque force generator, where meshing teeth are formed on one end face of the auxiliary output wheel, the clutch device comprises a transmission toothed disc that can slide on the rotating shaft and is arranged on one side of each auxiliary output wheel, and the transmission toothed disc can keep rotating synchronously with the rotating shaft; and transmission teeth are provided at one end of the transmission toothed disc, and the transmission teeth are arranged to face the meshing teeth of the auxiliary constant torque force generator so as to form meshing between the transmission teeth and the meshing teeth when approaching each other.

The constant torque force generator, where clamping teeth are formed on an inner peripheral side of the transmission toothed disc, clamping grooves are correspondingly formed on an outer peripheral side of the rotating shaft, and the clamping teeth are correspondingly matched with the clamping grooves, so that the transmission toothed disc and the rotating shaft can keep rotating synchronously.

The constant torque force generator, where the transmission toothed disc is connected with an elastic member, so that the transmission teeth of the transmission toothed disc are separated from the meshing teeth of the auxiliary constant torque force generator under normal conditions; and

an insert piece that can be cut in radially is arranged on the radial outer side of each transmission toothed disc, and one end of the insert piece facing the transmission toothed disc is an insert blade with a slope.

The constant torque force generator, where the other end of the insert piece is provided with a tooth row and is slidably located in a ferrule, the ferrule is fixed, the ferrule is provided with a gear that can be toggled or rotated by a knob, and the gear is meshed with the tooth row of the insert piece.

The constant torque force generator, where the power output member is an independent output wheel, a rotating shaft is provided into and extended through the independent output wheel, and the independent output wheel and the rotating shaft can rotate synchronously.

The constant torque force generator, where clamping teeth are formed on the inner peripheral side of the independent output wheel, clamping grooves are correspondingly formed on the outer peripheral side of the rotating shaft, and the clamping teeth are correspondingly matched with the clamping grooves, so that the independent output wheel and the rotating shaft can keep rotating synchronously.

The constant torque force generator, where the power output member and the at least one constant-force coil spring are located on the same plane.

The constant torque force generator, further including two panels, where the power output member and the constant-force coil spring are positioned between the two panels. A real-time constant-force tension device, including:
a rotatable rotating shaft;
a reel, around which a draw cord is wound, and which can drive the rotating shaft to rotate; and
an independent constant torque force generator, including a rotatable power output member and at least one constant-force coil spring, where a power connection is formed between the power output member and the rotating shaft, the at least one constant-force coil spring is arranged beside the power output member, one end of each constant-force coil spring is fixed, and the other end thereof is fixed to the power output member.

The real-time constant-force tension device, where the power output member of the independent constant torque force generator is an independent output wheel, clamping teeth are formed on the inner peripheral side of the independent output wheel, clamping grooves are correspondingly formed on the outer peripheral side of the rotating shaft, and the clamping teeth are correspondingly matched with the clamping grooves, so that the independent output wheel and the rotating shaft can rotate synchronously.

The real-time constant-force tension device, where the clamping teeth are arranged on the inner peripheral side of the reel, and are correspondingly matched with the clamping grooves of the rotating shaft, so that the reel can drive the rotating shaft to rotate synchronously.

The real-time constant-force tension device, further provided with at least one auxiliary constant torque force generator, where the auxiliary constant torque force generator includes a rotatable auxiliary output wheel and at least one constant-force coil spring, the at least one constant-force coil spring of the auxiliary constant torque force generator is arranged beside the auxiliary output wheel, one end of the constant-force coil spring is immobile, and the other end thereof is fixed to the auxiliary output wheel, and a power connection is formed between each of the auxiliary output wheels and the rotating shaft through a clutch device.

The real-time constant-force tension device, where the structure of the clutch device is as follows:

Meshing teeth are formed on one end face of the auxiliary output wheel, a transmission toothed disc that can slide on the rotating shaft is arranged on one side of each auxiliary output wheel, and the transmission toothed disc can keep rotating synchronously with the rotating shaft; and transmission teeth are provided at one end of the transmission toothed disc, and the transmission teeth are arranged to face the meshing teeth of the auxiliary constant torque force generator so as to form meshing between the transmission teeth and the meshing teeth when approaching each other.

The real-time constant-force tension device, where clamping teeth are formed on the inner peripheral side of the transmission toothed disc, clamping grooves are correspondingly formed on the outer peripheral side of the rotating shaft, and the clamping teeth are correspondingly matched with the clamping grooves, so that the transmission toothed disc and the rotating shaft can keep rotating synchronously.

The real-time constant-force tension device, where the transmission toothed disc is connected with an elastic member, so that the transmission teeth of the transmission toothed disc are separated from the meshing teeth of the auxiliary constant torque force generator under normal conditions; and

an insert piece that can be cut in radially is arranged on the radial outer side of each transmission toothed disc, and one end of the insert piece facing the transmission toothed disc is an insert blade with a slope.

The real-time constant-force tension device, where the other end of the insert piece is provided with a tooth row and is slidably located in a ferrule, the ferrule is fixed, the ferrule is provided with a gear that can be toggled or rotated by a knob, and the gear is meshed with the tooth row of the insert piece.

The real-time constant-force tension device, where the rotating shaft is fixed to a bracket, and a suction cup is provided on the bracket.

The real-time constant-force tension device, where the structure of the clutch device is as follows: a toggling mechanism is connected onto the transmission toothed disc, and the toggling mechanism can be linked and actuated through an external operating member to control the axial movement of the transmission toothed disc on the rotating shaft to achieve a clutch effect.

The real-time constant-force tension device, where the structure of the clutch device is as follows: the meshing teeth of the auxiliary output wheel are input bevel teeth, the transmission teeth of the transmission toothed disc are output bevel teeth, and the axial distance between the transmission toothed disc and the auxiliary output wheel is fixed, one side of the input bevel teeth and one side of the output bevel teeth are provided with a bevel toothed disc that can move radially, the bevel toothed disc can be linked through an externally arranged operating member to control the bevel toothed disc, the input bevel teeth and the output bevel teeth to be meshed synchronously to form a transmission or be demeshed synchronously to disconnect the transmission.

The present invention can replace a weight to generate adjustable torsion force and tensile force, and has the advantages of being portable, space-efficient, easily stored, low in cost, and adjustable, providing a real-time constant force, etc.

### BRIEF DESCRIPTION OF THE DRAWINGS

FIG. 1 is a schematic diagram of the overall structure of an auxiliary constant torque force generator;

FIG. 2 is a schematic diagram of the internal structure of the auxiliary constant torque force generator;

FIG. 3 is a schematic structural diagram of an auxiliary output wheel of an auxiliary constant torque force generator;

FIG. 4 is a schematic diagram of the overall structure of an independent constant torque force generator;

FIG. 5 is a schematic structural diagram of an independent output wheel of an independent constant torque force generator;

FIG. 6 is a schematic structural diagram of a rotating shaft;

FIG. 7 is a schematic diagram of the overall structure of a real-time constant-force tension device;

FIG. 8 is a schematic structural diagram of a reel;

FIG. 9 is a schematic diagram of the meshing state of an auxiliary output wheel of the auxiliary constant torque force generator and a transmission toothed disc;

FIG. 10 is a schematic structural diagram of a clutch device;

FIG. 11 is a schematic diagram of a state in which the clutch device extends out of an insert piece;

FIG. 12 is a schematic diagram of another structural form of a clutch device; and

FIG. 13 is a schematic diagram of still another structural form of a clutch device.

Description of reference numerals: Auxiliary constant torque force generator 10; Panel 11; Support column 12; Auxiliary output wheel 13; Input bevel tooth 131; Constant-force coil spring 14; Connecting column 15; Rotating shaft 20; Radial hole 22; Clamping groove 25; Independent constant torque force generator 30; Independent output wheel 33; Clamping tooth 35; Reel 40; Clutch device 60; Transmission toothed disc 61; Fixing portion 611; Output bevel tooth 612; Insert piece 62; insert blade 621; Tooth row 622; Ferrule 63; Gear 64; Toggling mechanism 65; Knob 66; Bevel toothed disc 67; Bracket 90; Suction cup 91.

### DETAILED DESCRIPTION

The purpose of the present invention is to provide an adjustable real-time constant-force tension device. As shown in FIG. 7, an independent constant torque force generator 30 is arranged on a rotating shaft 20 to form a basic constant tensile force, and then a plurality of auxiliary constant torque force generators 10 are arranged on the rotating shaft 20, a controllable clutch device 60 is adopted to enable each auxiliary constant torque force generator 10 and the rotating shaft 20 to switch the power on-off relationship, so as to provide real-time constant tensile force of different gradient magnitudes for a user to select.

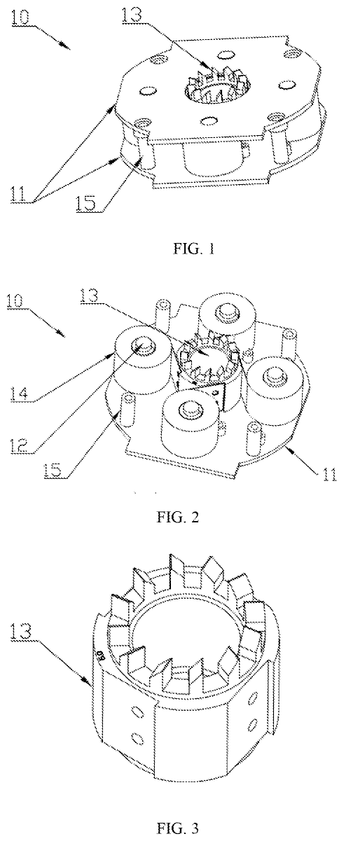

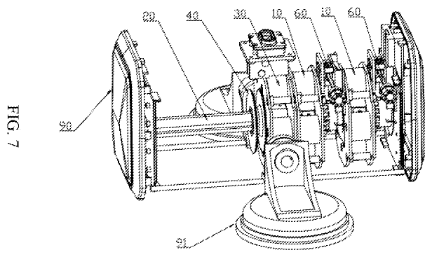

As shown in FIGS. 1, 2, 3, and 6, the auxiliary constant torque force generator 10 provided by the present invention, includes:
two oppositely arranged panels 11, fixedly connected to each other by support columns 12 and connecting columns 15;
a rotating shaft 20, passing through the two panels 11 in a vertical direction;
an auxiliary output wheel 13, disposed between the two panels 11 and freely rotatably sleeved on the rotating shaft 20, in which one-way meshing teeth are formed on one end face of the auxiliary output wheel 13;
four support columns 12, fixed between the two panels 11 and arranged around the periphery of the auxiliary output wheel 13; and
four constant-force coil springs 14, one end of each of which is immobile and wrapped around the support columns 12, and the other end thereof is fixed to the auxiliary output wheel 13.

In this way, when the auxiliary output wheel 13 rotates under tensile force, the four constant-force coil springs 14 will be driven to deform to provide resistance torque for the auxiliary output wheel 13, that is, the auxiliary constant torque force generator 10 can provide reverse tensile force. In fact, the number of the constant-force coil springs 14 is not limited to four, and may be one, two, three, four, five, six, seven, eight and more. By using different numbers of constant-force coil springs 14, the torque provided by the auxiliary constant torque force generator 10 can be changed in gradient.

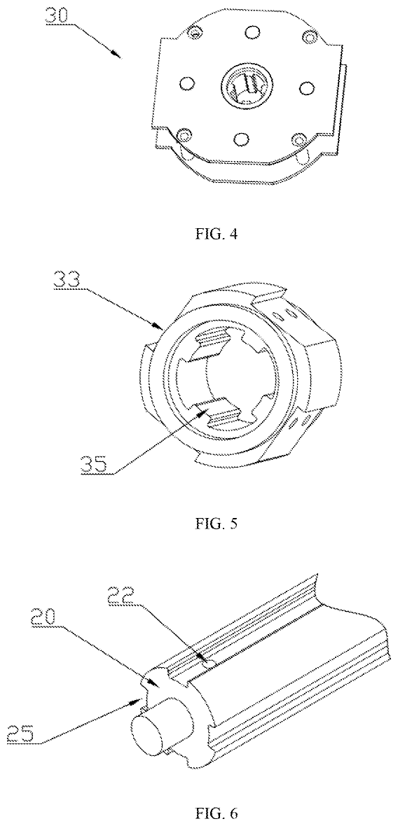

As shown in FIGS. 4, 5, and 6, the independent constant torque force generator 30 provided by the present invention is different from the auxiliary constant torque force generator 10 in that:

The auxiliary output wheel 13 is replaced with an independent output wheel 33. The independent output wheel 33 is no longer provided with one-way meshing teeth. Instead, clamping teeth 35 are formed on an inner peripheral side of the independent output wheel 33, clamping grooves 25 are correspondingly formed on an outer peripheral side of the rotating shaft 20, and when the independent output wheel 33 is sleeved onto the rotating shaft 20, the clamping teeth 35 are correspondingly matched with the clamping grooves 25, so that the independent output wheel 33 and the rotating shaft 20 keep rotating synchronously.

FIG. 7 is a schematic diagram of the overall structure of the real-time constant-force tension device provided by the present invention, where
the rotating shaft 20 is rotatably arranged on a bracket 90;
an independent constant torque force generator 30, four auxiliary constant torque force generators 10 (in order to see the internal details clearly, two auxiliary constant torque force generators 10 on the left are removed) and a reel 40 are arranged on the rotating shaft 20; a clutch device 60 is arranged between the auxiliary output wheel 13 of each auxiliary constant torque force generator 10 and the rotating shaft 20, so that the auxiliary output wheel 13 of each auxiliary constant torque force generator 10 can selectively be in power connection with the rotating shaft 20 or be disconnected with the rotating shaft; and in this way, a plurality of groups of tensile forces of different magnitudes are provided. Of course, the number of independent constant torque force generators 30 and the number of the auxiliary constant torque force generators 10 on the rotating shaft 20 are not limited to that shown in the above embodiment, and the actual number may be freely increased or decreased according to actual needs.

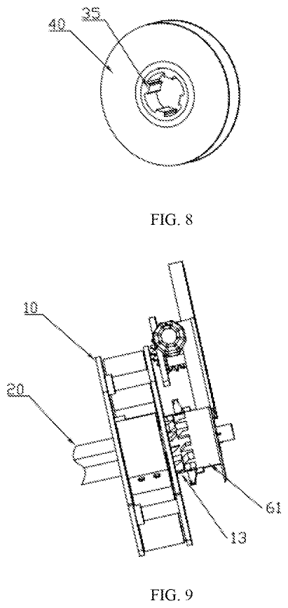

As shown in FIG. 8, the clamping teeth 35 are provided on the inner peripheral side of the reel 40 so as to be correspondingly matched with the clamping grooves 25 of the rotating shaft 20, so that the reel 40 can drive the rotating shaft 20 to rotate synchronously. A draw cord (not shown) can be wound around an outer peripheral side of the reel 40. By pulling the draw cord, the reel 40 can be rotated, thereby driving the rotating shaft 20 to rotate synchronously.

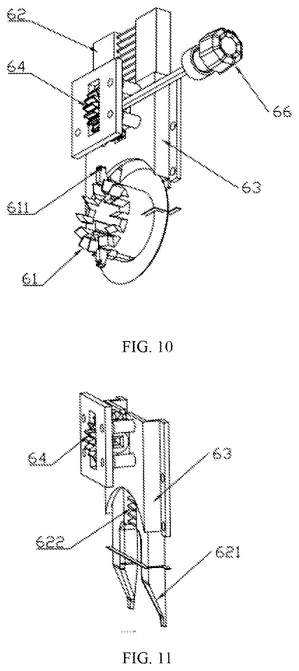

As shown in FIGS. 7, 9, 10, and 11, the structure of the clutch device 60 is as follows.

The axial position of each auxiliary constant torque force generator 10 is fixed, a transmission toothed disc 61 that can slide on the rotating shaft 20 is arranged on one side of each auxiliary constant torque force generator 10, clamping teeth 35 (not shown) are provided on an inner peripheral side of the transmission toothed disc 61, and the transmission toothed disc and the rotating shaft 20 keep rotating synchronously.

One-way transmission teeth are provided at one end of the transmission toothed disc 61, and the one-way transmission teeth are arranged to face and thus be able to mesh with the one-way meshing teeth of the auxiliary constant torque force generator 10.

Two fixing portions 611 are arranged on the transmission toothed disc 61, which can be used for hanging of one end of an elastic member (such as a tension spring, not shown), and the other end of the elastic member can be fixed at a radial hole 22 of the rotating shaft 20, so that the one-way transmission teeth of the transmission toothed disc 61 are separated from the one-way meshing teeth of the auxiliary constant torque force generator 10 under normal conditions.

An insert piece 62 is arranged on a radial outer side of each transmission toothed disc 61, one end of the insert piece 62 facing the transmission toothed disc 61 is an insert blade 621 with a slope, and the other end thereof is provided with a tooth row 622 and is slidably provided into a ferrule 63, the ferrule 63 is fixed, and the ferrule 63 is provided with a gear 64 that can be toggled or rotated by the knob 66. The gear 64 is meshed with the tooth row 622 of the insert piece 62, and by toggling the gear 64 to rotate by fingers, the insert piece 62 can be controlled to move radially relative to the transmission toothed disc 61. When the insert piece 62 moves downward, the slope of the insert blade 621 abuts against the transmission toothed disc 61, and the transmission toothed disc 61 is pushed to move axially, so that the one-way transmission teeth on the transmission toothed disc 61 are meshed with the one-way meshing teeth of the auxiliary constant torque force generator 10, and when the toothed disc moves upward, the transmission toothed disc 61 is pushed to move axially in the other direction under the action of an electric member, so that the one-way transmission teeth on the transmission toothed disc 61 is demeshed with the one-way meshing teeth of the auxiliary constant torque force generator 10.

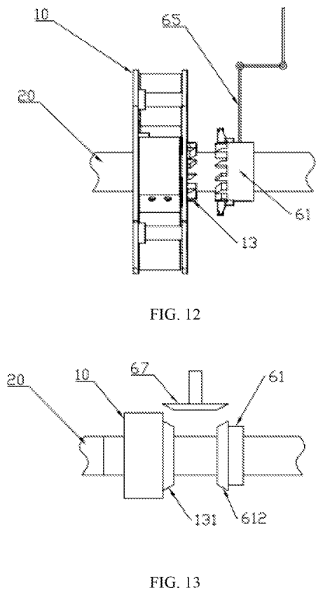

FIG. 12 is another feasible structure of the clutch device 60. A toggling mechanism 65 (such as a shift lever, a link mechanism, etc.) is connected onto the transmission toothed disc 61. By linking an external operating member such as buttons to control the axial movement of the transmission toothed disc 61 on the rotating shaft 20 to achieve a clutch effect. In the present embodiment, the elastic member may or may not be disposed.

FIG. 13 is another feasible structure of the clutch device 60. The one-way meshing teeth of the auxiliary output wheel 13 of the auxiliary constant torque force generator 10 are input bevel teeth 131, the one-way transmission teeth of the transmission toothed disc 61 are output bevel teeth 612, and the axial distance between the transmission toothed disc 61 and the auxiliary output wheels 13 is fixed. At this time, a bevel toothed disc 67 that can move radially is provided on one side of the input bevel teeth 131 and one side of the output bevel teeth 612. By linking an externally arranged operating members such as buttons to the bevel toothed disc 67, the bevel toothed disc 67 and the input bevel teeth 131 and the output bevel teeth 612 are controlled to be meshed synchronously to form a transmission, or be demeshed synchronously to disconnect the transmission.

As shown in FIG. 7, two suction cups 91 may be fixed to the bracket 90. The suction cups 91 can easily fix the bracket 90 on a smooth surface. At this time, by pulling the draw cord on the reel 40 (equipped with a handle, and a pulley), the resistance provided by the independent constant torque force generator 30 and the auxiliary constant torque force generator 10 may be used to perform various fitness exercises. Therefore, the present invention has the advantages of being portable, space-efficient, easily stored, low in cost, and adjustable, providing a real-time constant force, etc. By operating each clutch device 60, the auxiliary constant torque force generators 10 may participate in the work with different numbers and different torques, provide gradient resistance at various levels and adapt to the different requirements of trainers with different strength bases.

In addition to being applied to fitness equipment, the present invention may also be applied to machinery industry, aerospace, automobiles and other technical fields to achieve the technical effect of replacing weights.

The above description is only illustrative of the present invention, not restrictive. Those of ordinary skill in the art will understand that many modifications, changes or equivalents can be made without departing from the spirit and scope defined by the claims. However, all will fall within the protection scope of the present invention.

1. A constant torque force generator, comprising:
a rotatable power output member; and
at least one constant-force coil spring, arranged beside the power output member, one end thereof being immobile, and the other end thereof being fixed to the power output member.

2. The constant torque force generator according to claim 1, wherein the power output member is an auxiliary output wheel, a rotating shaft that can rotate relatively freely is provided into and extended through the auxiliary output wheel, and a power connection is formed between the auxiliary output wheel and the rotating shaft through a clutch device.

3. The constant torque force generator according to claim 2, wherein meshing teeth are formed on one end face of the auxiliary output wheel, the clutch device comprises a transmission toothed disc that can slide on the rotating shaft and is arranged on one side of each auxiliary output wheel, and the transmission toothed disc and the rotating shaft keep rotating synchronously; and wherein transmission teeth are provided at one end of the transmission toothed disc and arranged to face the meshing teeth of the auxiliary constant torque force generator so as to form meshing between the transmission teeth and the meshing teeth when approaching each other.

4. The constant torque force generator according to claim 3, wherein clamping teeth are formed on an inner peripheral side of the transmission toothed disc, clamping grooves are correspondingly formed on an outer peripheral side of the rotating shaft, and the clamping teeth are correspondingly matched with the clamping grooves so that the transmission toothed disc and the rotating shaft can keep rotating synchronously.

5. The constant torque force generator according to claim 3, wherein the transmission toothed disc is connected with an elastic member, so that the transmission teeth of the transmission toothed disc are separated from the meshing teeth of the auxiliary constant torque force generator under normal conditions; and
an insert piece that can be cut in radially is arranged on a radial outer side of each transmission toothed disc, and one end of the insert piece facing the transmission toothed disc is an insert blade with a slope.

6. The constant torque force generator according to claim 5, wherein the other end of the insert piece is provided with a tooth row and is slidably provided in a ferrule, the ferrule is fixed, the ferrule is provided with a gear that can be toggled or rotated by a knob, and the gear is meshed with the tooth row of the insert piece.

7. The constant torque force generator according to claim 1, wherein the power output member is an independent output wheel, a rotating shaft is provided into and extended through the independent output wheel, and the independent output wheel and the rotating shaft can rotate synchronously.

8. The constant torque force generator according to claim 7, wherein clamping teeth are formed on an inner peripheral side of the independent output wheel, clamping grooves are correspondingly formed on an outer peripheral side of the rotating shaft, and the clamping teeth are correspondingly matched with the clamping grooves so that the independent output wheel and the rotating shaft can keep rotating synchronously.

9. The constant torque force generator according to claim 1, wherein the power output member and the at least one constant-force coil spring are located on the same plane.

10. The constant torque force generator according to claim 1, further comprising two panels, the power output member and the constant-force coil spring being positioned between the two panels.

11. A real-time constant-force tension device, comprising:
a rotatable rotating shaft;
a reel, around which a draw cord is wound, and which can drive the rotating shaft to rotate; and
an independent constant torque force generator, comprising a rotatable power output member and at least one constant-force coil spring, wherein a power connection is formed between the power output member and the rotating shaft, the at least one constant-force coil spring is arranged beside the power output member, one end of each constant-force coil spring is immobile, and the other end thereof is fixed to the power output member.

12. The real-time constant-force tension device according to claim 11, wherein the power output member of the independent constant torque force generator is an independent output wheel, clamping teeth are formed on an inner peripheral side of the independent output wheel, clamping grooves are correspondingly formed on an outer peripheral side of the rotating shaft, and the clamping teeth are correspondingly matched with the clamping grooves so that the independent output wheel and the rotating shaft can keep rotating synchronously.

13. The real-time constant-force tension device according to claim 12, wherein the clamping teeth are provided on an inner peripheral side of the reel, and are correspondingly matched with the clamping grooves of the rotating shaft, so that the reel can drive the rotating shaft to rotate synchronously.

14. The real-time constant-force tension device according to claim 11, further provided with at least one auxiliary constant torque force generator, wherein the auxiliary constant torque force generator comprises a rotatable auxiliary output wheel and at least one constant-force coil spring, at least one constant-force coil spring of the auxiliary constant torque force generator is arranged beside the auxiliary output wheel, one end of the constant-force coil spring is immobile, and the other end thereof is fixed to the auxiliary output wheel, and a power connection is formed between each of the auxiliary output wheels and the rotating shaft through a clutch device.

15. The real-time constant-force tension device according to claim 14, wherein the structure of the clutch device is as follows:
meshing teeth are formed on one end face of the auxiliary output wheel, a transmission toothed disc that can slide on the rotating shaft is arranged on one side of each auxiliary output wheel, the transmission toothed disc can keep rotating synchronously with the rotating shaft; and transmission teeth are provided at one end of the transmission toothed disc, and arranged to face the meshing teeth of the auxiliary constant torque force generator so as to form meshing between the transmission teeth and the meshing teeth when approaching each other.

16. The real-time constant-force tension device according to claim 15, wherein clamping teeth are formed on an inner peripheral side of the transmission toothed disc, clamping grooves are correspondingly formed on an outer peripheral side of the rotating shaft, and the clamping teeth are correspondingly matched with the clamping grooves so that the transmission toothed disc and the rotating shaft can keep rotating synchronously.

17. The real-time constant-force tension device according to claim 15, wherein the transmission toothed disc is connected with an elastic member, so that the transmission teeth of the transmission toothed disc are separated from the meshing teeth of the auxiliary constant torque force generator under normal conditions; and
an insert piece that can be cut in radially is arranged on a radial outer side of each transmission toothed disc, and one end of the insert piece facing the transmission toothed disc is an insert blade with a slope.

18. The real-time constant-force tension device according to claim 17, wherein the other end of the insert piece is provided with a tooth row and is slidably located in a ferrule, the ferrule is fixed, the ferrule is provided with a gear that can be toggled or rotated by a knob, and the gear is meshed with the tooth row of the insert piece.

19. The real-time constant-force tension device according to claim 11, wherein the rotating shaft is fixed to a bracket, and a suction cup is provided on the bracket.

20. The real-time constant-force tension device according to claim 15, wherein the structure of the clutch device is as follows: a toggling mechanism is connected onto the transmission toothed disc, and the toggling mechanism can be linked and actuated through an external operating member to control the axial movement of the transmission toothed disc on the rotating shaft to achieve a clutch effect.

21. The real-time constant-force tension device according to claim 15, wherein the structure of the clutch device is as follows: the meshing teeth of the auxiliary output wheel are input bevel teeth, the transmission teeth of the transmission toothed disc are output bevel teeth, an axial distance between the transmission toothed disc and the auxiliary output wheel is fixed, one side of the input bevel teeth and one side of the output bevel teeth are provided with a bevel toothed disc that can move radially, and by linking an externally arranged operating member to the bevel toothed disc, the bevel toothed disc and the input bevel teeth and the output bevel teeth are controlled to be meshed synchronously to form a transmission, or to be demeshed synchronously to disconnect the transmission.
